(19) United States
(12) Patent Application Publication
(10) Pub. No.: US 2002/0022465 A1
(43) Pub. Date: Feb. 21, 2002

(54) Apparatus and method for integrated frequency hopping and GPS receiver

(76) Inventors: Michael J. McCullagh, Co. Antrim (IE); David M. Moloney, Phibsboro (IE)

Correspondence Address: Robert B. O'Rourke, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/729,763

(22) Filed: Dec. 4, 2000

Related U.S. Application Data
(60) Provisional application No. 60/225,864, filed on Aug. 15, 2000.
(60) Provisional application No. 60/244,564, filed on Oct. 30, 2000.

(51) Int. Cl. H04B 1/06

(52) U.S. Cl. 455/260; 331/18

(57) ABSTRACT

A method and apparatus of an integrated frequency hopping/GPS receiver and a corresponding frequency synthesizer are described.

The present application hereby claims the benefit of the filing date of a related Provisional Application filed on Aug. 15, 2000, and assigned Application Ser. No. 60/225,864; and Provisional Application filed on Oct. 30, 2000, and assigned Application Ser. No. 60/244,564.

### FIELD OF THE INVENTION

The field of invention relates to wireless communications generally; and more specifically, to an integrated frequency hopping/GPS receiver and a corresponding frequency synthesizer.

### BACKGROUND

Frequency Hopping

The industry standard referred to as “BLUETOOTH” provides for 79 wireless channels that are carried within a 2.400 GHz to 2.482 GHz band (the ISM band). Each of the 79 channels are approximately 1 MHz wide and are carried at frequencies spaced 1 MHz apart. That is, the first channel is carried at 2.402 GHz and spans between 2.4015 GHz and 2.4025 GHz, the second channel is carried at 2.403 GHz and spans between 2.4025 GHz and 2.4035 GHz, the third channel is carried at 2.404 GHz and spans between 2.4035 GHz and 2.4045 GHz, etc., and the seventy ninth channel is carried at 2.480 GHz and spans between 2.4795 GHz and 2.4805 GHz.

A wireless device is a device that transmits and receives wireless signals. Examples of wireless devices include wireless local area network (WLAN) equipment, cellular phones and wireless handheld personal digital assistants (PDAs). Other types of wireless devices are also possible. A wireless device synthesizes (i.e., creates) a local frequency (fs) that corresponds to the carrier frequency of a desired channel. Thus, if a transmitting wireless device is to transmit information over the first BLUETOOTH channel, the transmitting wireless device will synthesize a local frequency of 2.402 GHz.

Similarly, if a receiving wireless device is to receive information over the third BLUETOOTH channel, the receiving wireless device will typically synthesize a local frequency that is a fixed amount beneath 2.404 GHz (e.g., 3 MHz beneath 2.404 GHz such that a local frequency of 2.401 GHz is synthesized) in order to downconvert the received signal to an intermediate frequency. More details regarding downconversion are provided further below.

BLUETOOTH employs a spread spectrum technology referred to as frequency hopping. Frequency hopping implements a wireless connection by spreading the communication flow between two or more wireless devices over a number of different channels. Better said, wireless devices exchange information by continually “changing the channel” over the course of the wireless connection that is established between them (which is also referred to as a piconet).

FIG. 1 shows an exemplary portion of a piconet that exists between a first wireless device and a second wireless device. Packet 101a is sent from the first wireless device to the second wireless device during time T1a; packet 101b is sent from the second wireless device to the first wireless device during time T1b; and packet 101c is sent from the first wireless device to the second wireless device during time T1c.

According to the “channel changing” approach of a frequency hopped piconet, each of the packets 101a, 101b, 101c is sent over a different channel. That is, packet 101a is sent over a first channel (e.g., the third BLUETOOTH channel that is carried at 2.404 GHz), packet 101b is sent over a second channel (e.g., the twenty second BLUETOOTH channel that is carried at 2.423 GHz), and packet 101c is sent over a third channel (e.g., the seventy ninth BLUETOOTH channel that is carried at 2.480 GHz).

A change in channel corresponds to a change in carrier frequency. Thus, over the course of a piconet, a wireless device has to continually change the aforementioned local frequency. For example, continuing with the example provided just above, the first wireless device generates a 2.404 GHz local frequency for the duration of time T1a in order to transmit the first packet 101a.

Then, during time T2a, the first wireless device changes the local frequency from 2.404 GHz to 2.420 GHz (which is equal to 3 MHz less than the carrier frequency 2.423 GHz of the twenty third channel) so that the second packet 101b may be received during time T1b. Then, similarly, during time T2b the first wireless device changes the local frequency from 2.420 GHz to 2.480 GHz so that the third packet 101c may be transmitted during time T1c. BLUETOOTH is presently organized such that time periods T1a, T1b, and T1c are 405 us and time periods T2a and T2b are 220 us.

GPS

FIG. 2 shows an exemplary depiction of the Global Positioning System (GPS). The GPS presently includes 24 satellites that orbit the earth while continually broadcasting their position and local time. The broadcasts of four satellites 202a, 202b, 202c and 202d are shown reaching a portion of the earth's surface 204. Based upon the broadcasts from these four satellites 202a through 202d, a wireless device can determine its exact location 203 on (or above) the earth's surface 204.

GPS employs another spread spectrum technology referred to as “direct sequence” spread spectrum with code division multiple access. In code division multiple access, frequency usage is conserved by broadcasting each signal within its corresponding channel where each channel is defined by the same carrier frequency but a different modulation code. Thus, each satellite 102a through 102d may broadcast at the same carrier frequency (e.g., 1.57542 GHz for the GPS L1 band) yet modulate its signal according to a different code.

That is, the broadcast from satellite 102a is modulated with a first code, the broadcast from satellite 102b is modulated with a second code, etc. By demodulating with the same code that is unique to a particular satellite's broadcast, a receiving device (e.g., at location 103) can successfully demodulate the broadcast even though it shares the same carrier frequency with broadcasts from other satellites. Typically, a wireless GPS device is designed to individually demodulate received information with every code used in the GPS system (e.g., by demodulating, in parallel, with each GPS code). As such, at any time, a wireless GPS device can simultaneously receive signals from all visible GPS satellites.

Integration of Frequency Hopping and GPS

Due to the proliferation of wireless information and wireless communication, high demand is expected for wireless devices that can not only communicate within a frequency hopped wireless network (such as BLUETOOTH) but also receive GPS information.

### SUMMARY OF INVENTION

A method and apparatus of an integrated frequency hopping/GPS receiver and a corresponding frequency synthesizer.

### BRIEF DESCRIPTION OF THE DRAWINGS

The present invention is illustrated by way of example, and not limitation, in the Figures of the accompanying drawings in which:

FIG. 1 shows an exemplary portion of a piconet that exists between a first wireless device and a second wireless device;

FIG. 2 shows an exemplary depiction of the Global Positioning System (GPS);

FIG. 3a shows a wireless receiver;

FIG. 3b shows a first digitizing module;

FIG. 3c shows a second digitization module;

FIG. 4 shows a frequency synthesizer;

FIG. 5a shows an integrated BLUETOOTH/GPS receiver and frequency synthesizer;

FIG. 5b shows a method of operation for the integrated BLUETOOTH/GPS receiver and frequency synthesizer of FIG. 5a;

FIG. 6 shows an exemplary RF module that may be used by the integrated BLUETOOTH/GPS receiver of FIG. 5a;

FIG. 7 shows an exemplary intermediate frequency (IF) module that may be used by the integrated BLUETOOTH/GPS receiver of FIG. 5a;

FIG. 8a shows a first exemplary digitizing module that may be employed by the integrated BLUETOOTH/GPS receiver of FIG. 5a;

FIG. 8b shows a second exemplary digitizing module that may be employed by the integrated BLUETOOTH/GPS receiver of FIG. 5a;

FIG. 9a shows a frequency synthesizer embodiment that generates a local frequency for both a GPS signal and a BLUETOOTH signal;

FIG. 9b shows another frequency synthesizer embodiment that generates a local frequency for both a GPS signal and a BLUETOOTH signal;

FIG. 10a shows a regenerative divider that may be used in the frequency synthesizer embodiment of FIG. 9a;

FIG. 10b shows another regenerative divider that may be used in the frequency synthesizer embodiment of FIG. 9b.

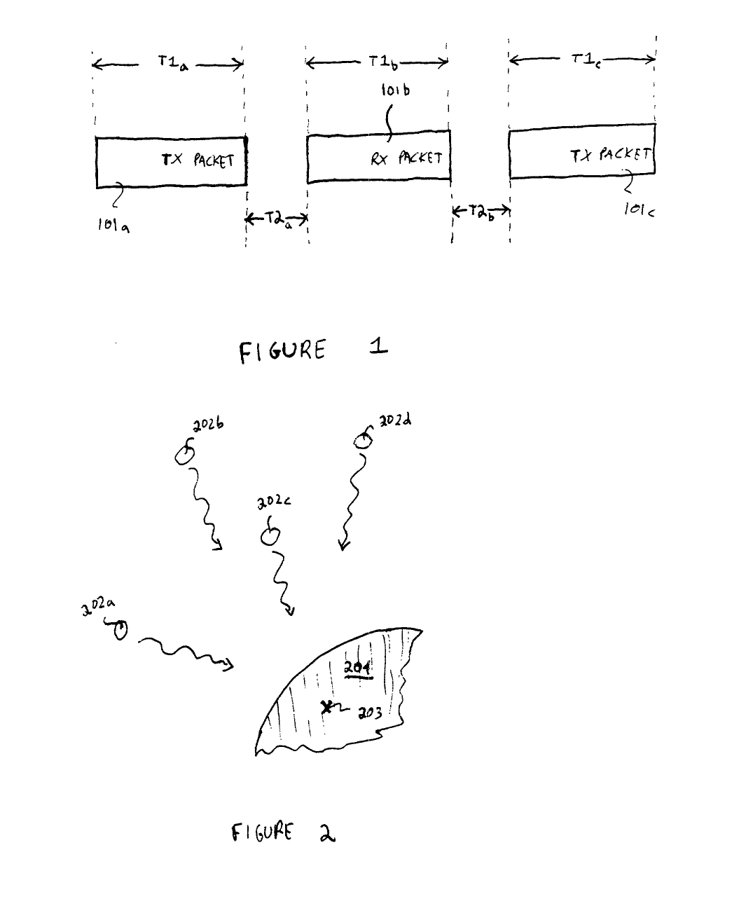

### DETAILED DESCRIPTION

The following discusses an integrated apparatus and method for receiving BLUETOOTH and GPS signals. However, before the integrated approach is discussed, underlying concepts with respect to wireless GPS and BLUETOOTH signal reception are first discussed so that various design perspectives associated with differences between the two signal types (BLUETOOTH and GPS) may be understood.

It is important to point out that even though the following discussion is limited to BLUETOOTH it is also applicable to BLUETOOTH's “sister” industry standards referred to as “HomeRF” and IEEE 802.11 (FH). BLUETOOTH, HomeRF and 802.11 (FH), although directed to different spatial ranges, are each frequency hopping technologies that operate as described in the background. As such, the following discussion is not to be construed as limited only to BLUETOOTH and should be understood to be equally applicable to HomeRF and 802.11 (FH). Other frequency-hopping schemes (e.g., Digital Enhanced Cordless Telecommunications (DECT) among possible others) may also benefit from the teachings provided below so as to provide integrated frequency-hopping/GPS reception.

1.0 RECEIVER

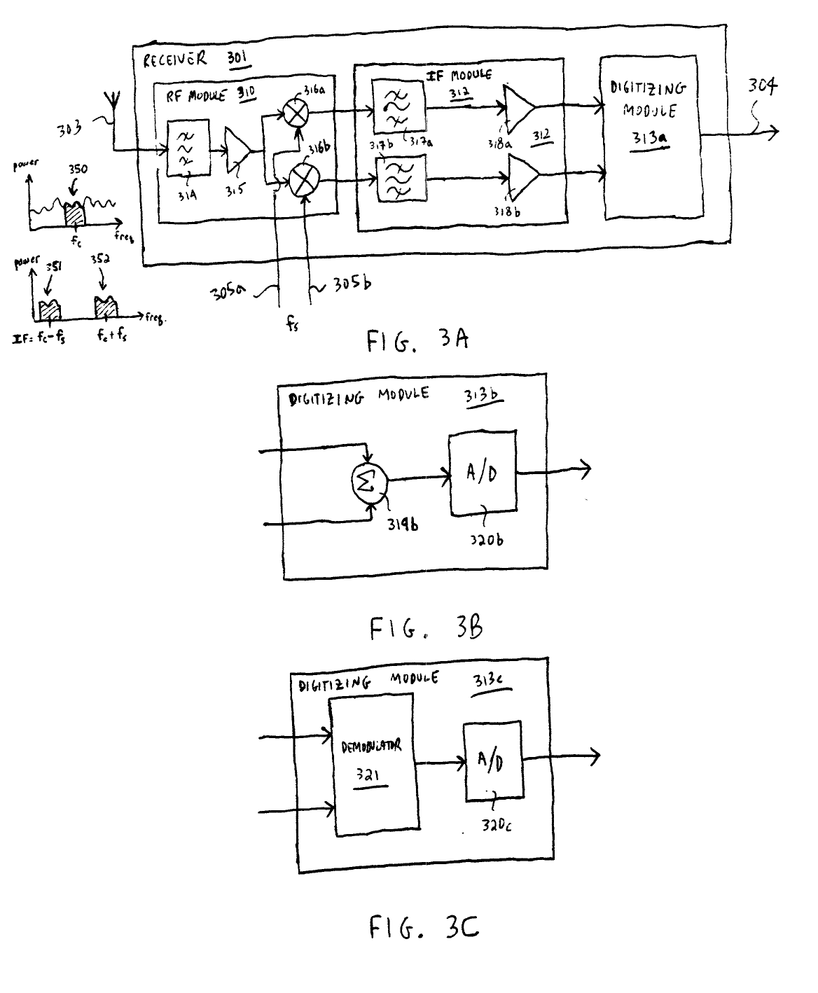

FIG. 3a shows a high level depiction of a wireless receiver 301 that is applicable to either BLUETOOTH signals or GPS signals. A wireless receiver may be viewed as having three functional sections: 1) a Radio Frequency (RF) module 310; 2) an intermediate frequency (IF) module 312; and 3) a digitizing module 313. Each of these are briefly discussed below.

a) RF Module

An RF module 310 is responsible for retrieving the content of a channel to be received from an air medium. An antennae 303 receives radiation from the air medium surrounding the wireless device. The desired spectral portion 350 of the received radiation is passed by an RF filter 314. For a BLUETOOTH receiver, the RF filter 314 is typically a bandpass filter that approximately passes the ISM band (e.g., between 2.400 GHz and 2.482 GHz). For a GPS receiver, the RF filter 314 is typically a bandpass filter that passes frequencies proximate to the carrier frequency of the particular GPS band being received (e.g., between 1.565 and 1.585 GHz for the GPS L1 band).

Amplification stage 315 typically includes one or more low noise amplifiers (LNAs) that amplify the desired spectral portion 350 that is passed by the RF filter 314. After amplification, the desired spectral portion 350 is mixed (i.e., multiplied) with a pair of downconversion signals that are provided at inputs 305a and 305b. A first downconversion signal is provided at a first input 305a and a second downconversion signal is provided at a second input 305b. The first and second downconversion signals have the same frequency (which is the aforementioned local frequency (fs)) and a 90 degree phase difference with respect to one another.

The channel to be received is determined by the local frequency fs of the downconversion signals. Thus, for a multiple channel receiver (such as a BLUETOOTH receiver), the local frequency fs changes if the channel to be received changes. However, for a single carrier frequency receiver (such as a GPS receiver configured to receive only one GPS band), the local frequency fs remains constant.

For either a BLUETOOTH receiver or a GPS receiver, the local frequency fs (as mentioned above) may be a fixed amount beneath the carrier frequency fc of the channel to be received (e.g., fs=fc−3 MHz). This fixed amount (which may be expressed as fc−fs) is commonly referred to as the intermediate frequency (IF). By mixing the amplified RF filter 314 output in this manner, the desired spectral portion 350 is translated to a higher frequency spectral portion 352 and a lower frequency spectral portion 351. According to basic mixing principles, the content of the desired channel (i.e., the signal) is located at fc−fs within the lower frequency portion 351 and fc+fs within the higher frequency portion 352.

b) Intermediate Frequency (IF) Module

The IF module 312 passes the content of a desired channel from the lower frequency portion 351 and presents approximately equal signal power to the digitizing module 313a under various received signal strength conditions.

The intermediate frequency filters 317a, 317b are tailored to pass the content of a desired channel from the lower frequency portion 351. The passband of each IF filter 317a,b may be characterized by its frequency position and its bandwidth. The frequency position, as described above, corresponds to the intermediate frequency fc−fs. The bandwidth of each IF filter 317a, 317b has a spectral width approximately equal to the width of the channel.

For BLUETOOTH signals, as described above, each of the 79 channels have a bandwidth of approximately 1.0 MHz. For GPS signals, the code modulation described above consumes approximately 2 MHz of bandwidth. As such, for a BLUETOOTH receiver embodiment, the passband of the IF filters 317a, 317b may be designed to have a spectral width of approximately 1.25 MHz (e.g., slightly larger than the bandwidth of the channel). Correspondingly, a GPS receiver embodiment may design the passband of the IF filters 317a, 317b to have a spectral width of approximately 2.25 Mhz. Other passbands are possible.

Recall that the IF module 312 also presents approximately equal signal power to the digitizing module 313. Amplifiers 318a,b, which respectively receive the output of IF filters 317a,b provide this function. Typically, approximately equal power is provided over the “designed for” dynamic range of the receiver. Dynamic range is the difference between the strongest received signal that the receiver can handle and the weakest received (i.e., minimum detectable) signal.

Two approaches are typically used for amplifiers 318a,b: a limiting approach; or an automatic level control (ALC) approach. A limiting approach applies a very large gain to all signals. Strongly received signals result in amplifier output clipping (which causes a received sinusoid waveform to appear more like a digital pulse stream). An ALC approach applies amplification inversely with the strength of the received signal. That is, weak signals are given more amplification than strong signals. An ALC approach typically uses feedback to increase a variable gain amplifier's (VGA) amplification until a desired power level is observed at the amplifier output.

c) Digitizing Module

The digitizing module 313a converts the signal from the analog domain to the digital domain. Note that the digitizing module 313a output corresponds to the receiver 301 output. Typically an analog to digital (A/D) converter is used by the digitizing module 313a to convert the received signal from an analog waveform to a series of digital data structures (e.g., bytes) having values representative of the waveform amplitude.

FIG. 3b shows a basic digitizing module 313b. Both quadrature arms (each of which flow from a separate mixer 316a, 316b) are combined (e.g., in an IQ combiner 319b) prior to the analog-to-digital conversion performed by the A/D converter 320b. Thus, for the digitizing module 313b embodiment of FIG. 3b, the receiver 301 output corresponds to a digital, modulated signal being carried at the intermediate frequency (also referred to as a digitized IF signal). A BLUETOOTH receiver or a GPS receiver may employ the basic digitizing module approach of FIG. 3b. In either case, the signal is demodulated after the analog to digital conversion provided by the digitizing module 313b.

Note that in an alternate embodiment (that is not shown in FIG. 3a,b,c for simplicity), the IQ combiner 319b may be eliminated. As such, each quadrature arm is separately converted into the digital domain by a pair of A/D converters (where a first A/D converter processes one quadrature arm and a second A/D converter processes the other quadrature arm).

FIG. 3c shows a more advanced digitizing module 313c that may be employed by a BLUETOOTH receiver. BLUETOOTH uses a frequency shift keyed (FSK) modulation approach (with gaussian filtering (GFSK)). In an FSK approach, binary 1s are distinguished from binary 0s by shifting the signal frequency. For example, a 1 is represented with a higher frequency while a 0 is represented with a lower frequency. Although the FSK approach lends itself to demodulation in the digital domain, the FSK approach also lends itself to demodulation in the analog domain.

Specifically, a demodulator 321 (that effectively behaves as a frequency to voltage converter), converts the higher FSK frequency into a first voltage and the lower FSK frequency into a second voltage. Digital 1s are therefore converted to the first voltage while digital 0s are converted to the second voltage. This activity reproduces the unmodulated signal within the transmitting device prior to modulation (also referred to as a baseband signal).

Because FSK lends itself to analog demodulation, a digitizing module 313c for a BLUETOOTH receiver may include a demodulator 321 placed prior to the A/D converter 320c. GPS signals generally do not lend themselves to analog demodulation (because the parallel demodulation scheme used to simultaneously retrieve the signal from each satellite would consume too much silicon surface area and electrical power). As such, GPS signals are typically demodulated after the A/D converter in the digital domain rather than the analog domain.

2.0 Frequency Synthesizer

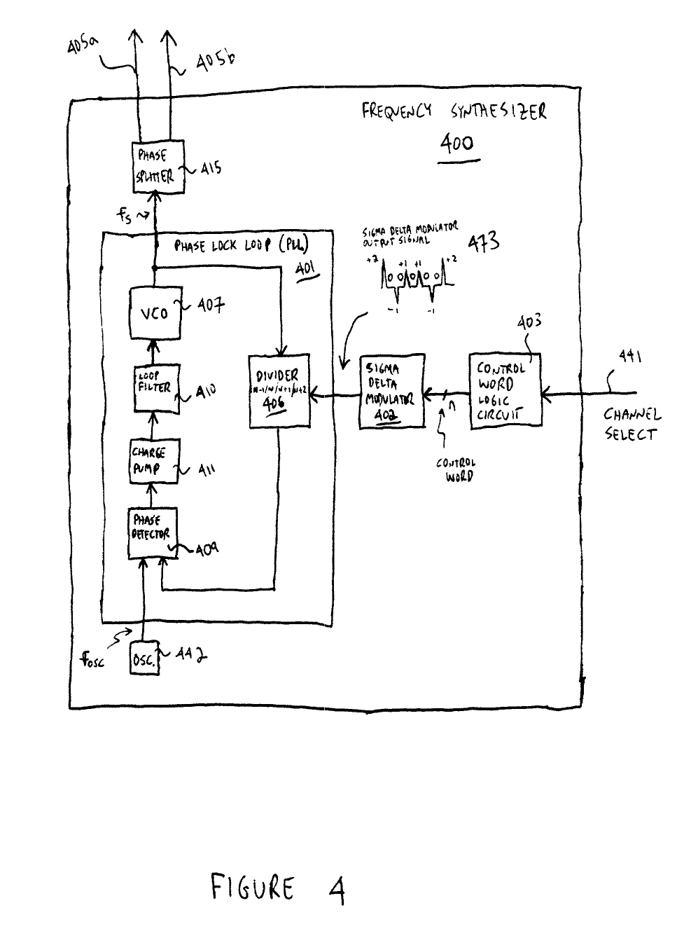

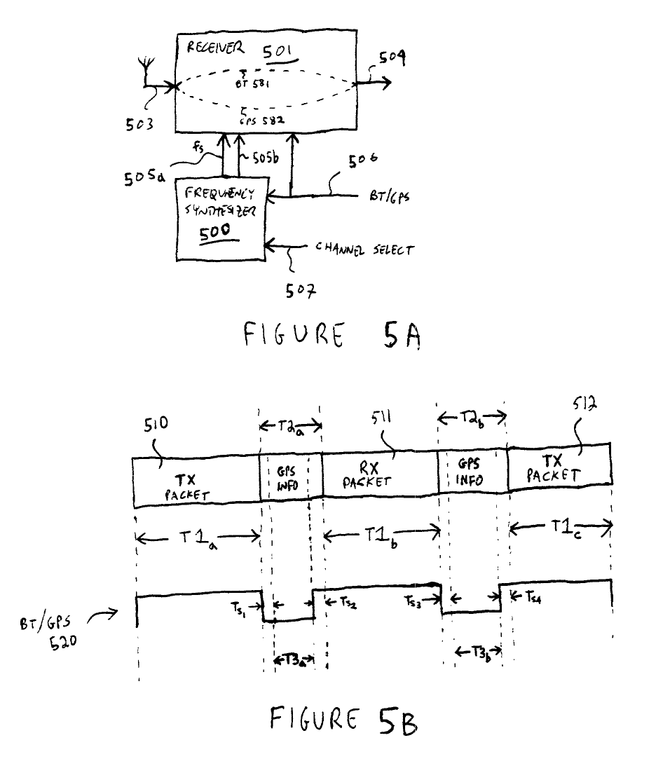

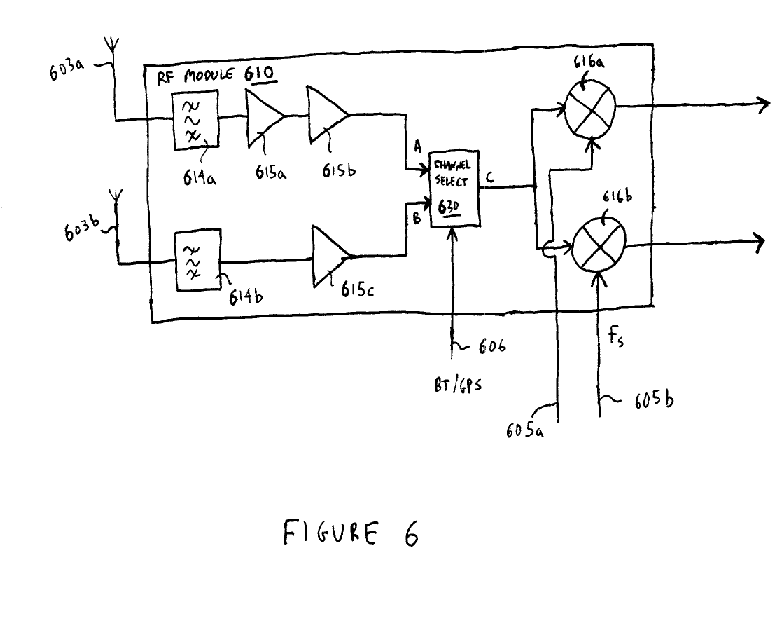

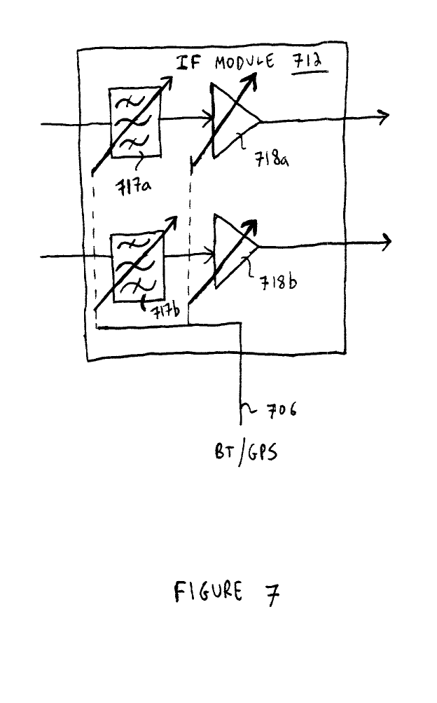

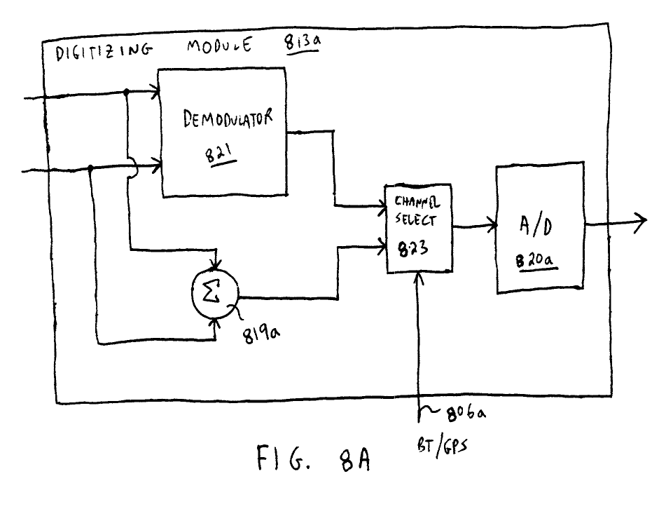

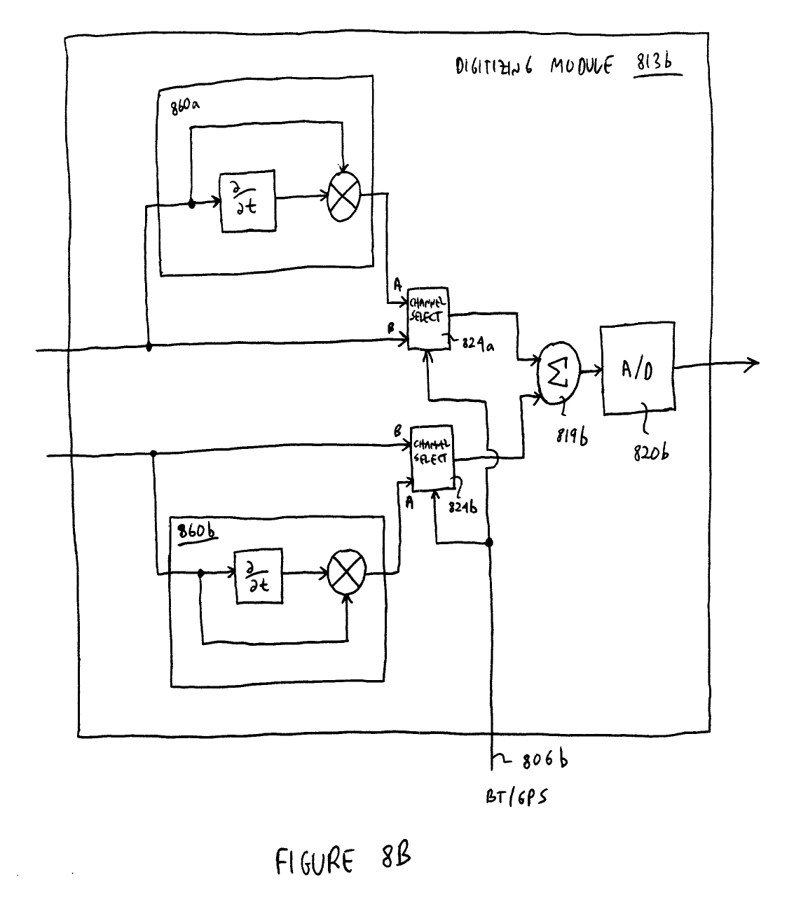

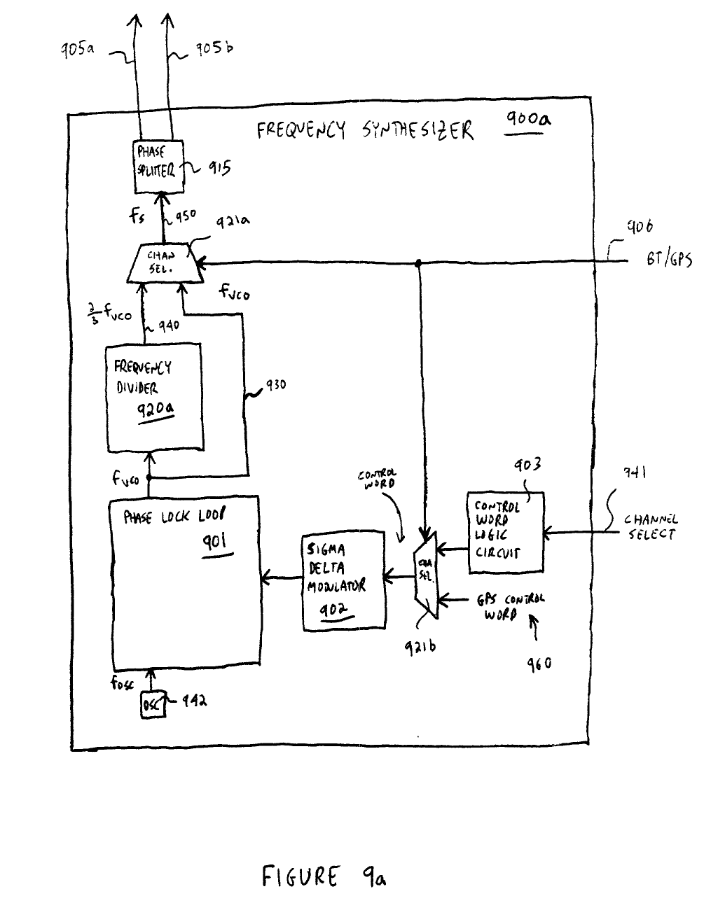

Recall that the downconversion signals provided at RF module inputs 305a and 305b have the same frequency (which is the aforementioned local frequency (fs)) and a 90 degree phase difference with respect to one another. A frequency synthesizer, such as the frequency synthesizer 400 shown in FIG. 4, may be used to generate both downconversion signals. That is, frequency synthesizer outputs 405a and 405b correspond to the RF module 310 inputs 305a and 305b observed in FIG. 3.

A frequency synthesizer 400 may be formed by coupling a sigma delta modulator 402 to a divider 406 that is located within the feedback path of a phase lock loop (PLL) circuit 401. The PLL circuit 401 is used to effectively multiply the frequency of a reference oscillator 442. That is, the PLL 401 output signal (which is the signal appearing at the output of the voltage controlled oscillator (VCO) 407) has a local frequency (fs) that is a multiple (N_{AVE}) of the reference oscillator 442 frequency (fosc). That is, fs=N_{AVE}·fosc.

The frequency fs of the VCO 407 output signal is divided within the feedback path of the PLL 401 by a divider 406. A divider 406 is a circuit that emits an output signal having a reduced frequency as compared to its input signal. Divider 406 allows the VCO 407 to operate at a higher frequency than the reference oscillator 442 (which effectively provides the desired frequency multiplication performed by the PLL circuit 401). The divider 406 may be a counter-like circuit that triggers an edge at its output signal after a number of edges are observed in the VCO 407 output signal.

The degree to which the frequency is reduced in the feedback path is referred to as the division or the division factor. Divider 406 has a second input used to control the division performed by the divider 406. A divider's division factor “N”, will vary (as discussed in more detail further ahead) depending upon the sigma delta modulator 402 output signal. Over the course of time in which a constant local frequency fs is produced, at one instance the division factor may be “N” while at another instance it may be “N−1”. Thus, as explained in more detail below, the division factor N varies even if a constant fs is produced.

Given that the division factor N varies, the average division factor realized over time (N_{AVE}) corresponds to the multiplication performed by the PLL 401. That is, the average frequency of the divider 406 output signal is fs/N_{AVE}. Phase detector 409 produces an output based upon the phase difference between the divider 406 output signal and the reference oscillator 442 signal. The phase detector 409 output is effectively integrated or averaged by loop filter 410 (via charge pump 411) which produces a loop filter 410 output voltage that is presented to the VCO 407 input. The VCO 407 output signal frequency fs is proportional to the voltage placed at the VCO 407 input.

Ideally, the loop filter 410 output voltage becomes stable (i.e., fixed or “locked”) when the frequency of the reference oscillator fosc becomes equal to fs/N_{AVE}; that is, when the VCO 407 output frequency fs becomes equal to N_{AVE}·fosc. Thus, in this manner, the PLL circuit 401 effectively multiplies the frequency of the reference oscillator 442 by a factor of N_{AVE}. Frequency synthesis performed according to the technique described above (i.e., modulating the division performed by a divider in a PLL feedback path) is commonly referred to as Fractional-N (or N-Fractional) synthesis.

In the embodiment of FIG. 4, a static control word logic circuit 403 is used to translate an indication of the desired channel (presented at the channel select input 441) into a control word (having n bits) that is submitted to the sigma delta modulator 402 input. That is, each channel has an associated, unique control word value. A unique sigma delta modulator 402 output signal is created for each unique control word value that is presented by the static control word logic circuit 403. The static control word logic 403 may be implemented with a look up table that lists a control word for each BLUETOOTH channel.

Sigma delta modulators are a class of circuit known in the art that craft an output having a beneficial spectral shape (e.g., by describing an input signal with higher frequencies than those emphasized by the input signal). The sigma delta modulator 402 output signal 473 (which may also be referred to as the modulator output signal, modulator output pattern and the like) controls the average division N_{AVE} performed by divider 406 and, in so doing, controls the frequency multiplication performed by the PLL circuit 401.

Because the frequency multiplication performed by the PLL 401 determines the PLL's output frequency fs; and because the PLL output frequency corresponds to the downconversion signal local frequency fs, the sigma delta modulator 402 output signal 473 is used to control which channel is received.

The sigma delta modulator 402 output signal 473 is a sequence of random or pseudo random values. An example of a sigma delta modulator 402 output signal 473 having four discrete output values (−1, 0, +1 and +2) is shown in FIG. 4. Other output values are possible. The number of output values typically depends upon the order of the sigma delta modulator. The corresponding divider 406 has four discrete division factors: N−1; N; N+1; and N+2.

Each of the different division factors may be used to divide the frequency of the VCO output signal. For example, if N of the divider 406 is configured to be equal to 92, the divider 406 is designed to divide at factors of 91, 92, 93 and 94. Thus, if the sigma delta modulator 402 output is −1 the division factor is N−1 (e.g., 91); if the sigma delta modulator 402 output is 0 the division factor is N (e.g., 92); if the sigma delta modulator 402 output is +1 the division factor is N+1 (e.g., 93); and if the sigma delta modulator 402 output is +2 the division factor is N+2 (e.g., 94).

For each control word (i.e., for each channel select value 441), the sigma delta modulator 402 will produce a sequence of values having a unique overall average value that corresponds to the division factor N_{AVE} used to select the appropriate channel. As such, for each channel select value 441, a local frequency fs used to receive the desired channel is synthesized. Phase splitter 415 then creates a pair of downconversion signals having a phase difference of 90 degrees.

The frequency synthesizer 400 described above is typically used to generate local frequencies suitable for receiving and transmitting information along more than one carrier frequency. As such, frequency synthesizer 400 is typically used for multiple carrier frequency environments such as BLUETOOTH. Since GPS applications typically involve only one carrier frequency, multiple reference frequencies do not need to be generated. A GPS receiver's local frequency is typically synthesized, therefore, with a simple PLL (e.g., that performs fixed multiplication of a reference oscillator frequency) rather than a frequency synthesizer circuit 400 as seen in FIG. 4.

3.0 Integrated BLUETOOTH/GPS Receiver and Frequency Synthesizer

a. Overview

FIG. 5a shows an integrated GPS/BLUETOOTH receiver 501 that accepts downconversion signals 505a, 505b from a frequency synthesizer 500. The receiver 501 and frequency synthesizer 500 are configured to enable the reception of BLUETOOTH or GPS signals depending on the state of a BT/GPS control input 506.

If the state of the BT/GPS control input 506 is positioned to enable BLUETOOTH reception, the channel select input 507 to the frequency synthesizer 500 determines the local frequency (fs) of a pair of downconversion signals 505a, 505b used to receive the desired channel (which is indicated at the channel select input 507). If the state of the BT/GPS control input 506 is positioned to enable GPS reception, the frequency synthesizer 500 generates a pair of downconversion signals having a local frequency used to receive GPS broadcasts within a GPS band.

Furthermore, as described in more detail below, the state of the BT/GPS control input 506 may also be used to affect the signal processing performed by the receiver 501 so as to better receive the particular type of signal sought (i.e., BLUETOOTH or GPS). Specifically, one or more parameters or techniques associated with the signal processing performed by the receiver 501 (e.g., one or more of the following: RF or IF bandwidth, noise figure, RF or IF gain or amplification technique, demodulation, etc.) are altered in light of the state of the BT/GPS control input 506. As such, as seen in FIG. 5a, separate signal processing paths exist within the receiver 501: a BLUETOOTH signal processing path 581 and a GPS signal processing path 582.

The specific signal processing parameters and techniques associated the receiver 501 in the BLUETOOTH state (e.g., a specific RF or IF bandwidth, a specific noise figure, a specific RF or IF gain or amplification technique, whether or not demodulation is performed, etc.) may be referred to as the BLUETOOTH signal processing path 581. Similarly, the specific processing parameters and techniques performed by the receiver 501 in the GPS state (e.g., a specific RF or IF bandwidth, a specific noise figure, a specific RF or IF gain or amplification technique, etc.) may be referred to as the GPS signal processing path 582. A frequency hopping signal path is a broader characterization of a signal path that processes signals received from a frequency hopping network generally (rather than from a BLUETOOTH network specifically).

In an embodiment, if the state of the BT/GPS control input 506 is positioned to enable BLUETOOTH reception, the receiver output 504 produces a digitized, demodulated BLUETOOTH baseband signal (or digitized, modulated BLUETOOTH baseband signal, referred to as a digitized IF signal, depending on the designer's preference). However, if GPS reception is enabled, the receiver output 504 produces a digitized, modulated GPS signal (i.e., a digitized IF GPS signal).

FIG. 5b shows a methodology that may be employed by the apparatus of FIG. 5a to receive GPS information while it is engaged in a BLUETOOTH connection (i.e., a piconet) with another wireless device. Note that the frequency synthesizer 500 of FIG. 5a may be used to generate a local frequency for transmitting a packet as well as receiving a packet.

Thus, as seen during time T1a of FIG. 5a, the BT/GPS control signal 520 (which is presented at the BT/GPS control input 506) is configured to enable a BLUETOOTH local frequency from the frequency synthesizer 500 so that the first packet 510 can be transmitted (over the channel indicated by the channel select input 507). After the time T1a for the transmission of the first packet has expired, the BT/GPS control signal 520 toggles to enable the reception of GPS information.

During a transitory period Ts1, the PLL within the frequency synthesizer 500 is adjusted to produce the appropriate local frequency for receiving GPS information. After the PLL has settled, GPS signals are received during time period T3a. An amount of time Ts2 prior to the scheduled reception of the second BLUETOOTH packet 511, the BT/GPS control signal 520 is toggled back to the BLUETOOTH state so that the PLL within the frequency synthesizer 500 can be adjusted to the appropriate local frequency (that is used to receive the second BLUETOOTH packet 511).

Note that the channel select input 507 should reflect (e.g., before (or when) the BT/GPS control signal 520 is toggled back to the BLUETOOTH state) which channel the second packet 511 is to be received over. The next BLUETOOTH packet 511 is received over time period T1b. After the time T1b for the reception of the second packet has expired, the BT/GPS control signal 520 toggles again to enable the further reception of GPS information. After which, during a transitory period Ts3, the PLL within the frequency synthesizer 500 is adjusted to produce the appropriate local frequency for receiving GPS information.

After the PLL has settled, GPS signals are received during time period T3b. An amount of time Ts4 prior to the scheduled transmission of the third BLUETOOTH packet 512, the BT/GPS control signal 520 is toggled back to the BLUETOOTH state so that the PLL within the frequency synthesizer 500 can be adjusted to the appropriate local frequency used to transmit the third BLUETOOTH packet 512. Again, note that the channel select input 507 should reflect (e.g., before (or when) the BT/GPS control signal 520 is toggled back to the BLUETOOTH state) which channel the third packet 512 is to be transmitted over. The third BLUETOOTH packet 511 is then transmitted over time period T1c.

As described above, time periods T1a, T1b, and T1c may correspond to 405 us while time periods T2a, and T2b correspond to 220 us. In an embodiment, the PLL is configured to be adjusted within 10 us. As such the time period T3a, T3b that may be consumed receiving GPS information in between the reception or transmission of BLUETOOTH packets may be 200 us in maximum BLUETOOTH throughput conditions.

However, it is important to point out that BLUETOOTH packets are only sent as needed. Thus, longer periods of time may often exist between the reception or transmission of consecutive BLUETOOTH packets. For example, if the second packet 511 is not to be received in FIG. 5b, GPS information may be continuously collected over time periods T3a, Ts2,T1b, Ts3, and T3b. By controlling the BT/GPS control signal 520 with intelligence responsible for understanding the scheduling of BLUETOOTH packets within the piconet (e.g., a BLUETOOTH link controller within the wireless device), the BT/GPS control signal 520 can be toggled from the GPS state to the BLUETOOTH as is appropriate.

Before continuing, note that the receiver 501 and frequency synthesizer 500 of FIG. 5a may be part of a transceiver that not only receives wireless signals but also transmits wireless signals. Thus, as alluded to above, the frequency synthesizer 500 may also be used to generate carrier frequencies used to transmit a wireless signal. As such, wireless transmission circuitry (not shown in FIG. 5a for simplicity) may be coupled to the output of the frequency synthesizer 500.

b. Integrated GPS/BLUETOOTH Receiver

FIG. 6 shows an embodiment of an RF module 610 that may be used by the integrated GPS/BLUETOOTH receiver of FIG. 5a. That is, similar to the RF module 310 of to FIG. 3a, RF module 610 of FIG. 6 retrieves the content of a channel to be received. However, when the BT/GPS control input 606 (which corresponds to the BT/GPS control input 506 of FIG. 5a) is positioned in the BLUETOOTH state, the RF module 610 retrieves BLUETOOTH signal(s); and, when the BT/GPS control input 606 is positioned in the GPS state, the RF module retrieves GPS signal(s).

As alluded to above, the appropriate local frequency (fs) is applied (from downconversion signals provided on inputs 605a, 605b) because the frequency synthesizer generates a local frequency based upon the position of the BT/GPS control input 606. However, as seen in FIG. 6, the BT/GPS control input 606 controls a channel select unit 630 that selects between a first strip that is specially tailored to receive GPS signals (which flows from antennae 603a) and a second strip that is specially tailored to receive BLUETOOTH signals (which flows from antennae 603b). Note that the first strip may be viewed as part of a GPS signal processing path while the second strip may be viewed as part of a BLUETOOTH signal processing path.

According to the embodiment shown in FIG. 6, the first “GPS” strip includes antennae 603a, RF filter 614a, amplifier 615a and amplifier 615b. The second “BLUETOOTH” strip includes antennae 603b, RF filter 614b and amplifier 615c. As GPS signals (because they are transmitted from remote satellites) are typically weaker than BLUETOOTH signals, the GPS strip is designed with an emphasis on reducing channel noise.

Noise figure is a measure of how much noise is added to a signal. As such, the GPS strip is designed with a lower noise figure than the BLUETOOTH strip. In an embodiment, the noise figure of the GPS strip is less than or equal to 3 dB while the noise figure of the BLUETOOTH strip is less than or equal to 15 dB. In an embodiment, the GPS strip includes an off chip amplifier 615a and on chip amplifier 615b while the BLUETOOTH amplifier includes only an on chip amplifier 615c. On chip is a term that refers to a large semiconductor chip that can have a digital signal processor (DSP) and/or a general purpose processor integrated along with the receiver and frequency synthesizer and other parts of the receiver.

On-chip amplifiers are susceptible to noise from other circuitry on the chip, as such off chip amplifiers tend to have a lower noise figure than on chip amplifiers. Consistent with front end design principles, in order to keep amplifier induced noise to a minimum, the low noise figure amplifier 615a is the first amplifier in the strip. As such, only a small amount of amplifier induced noise is further amplified by subsequent amplification stages in the GPS strip.

In an embodiment, RF filter 614a has a passband corresponding to a desired spectral portion of GPS related radiation (e.g., 1.550 GHz to 2.000 GHz) while RF filter 614b has a passband corresponding to a desired spectral portion of BLUETOOTH related radiation (e.g., the ISM frequency band between 2.400 GHz and 2.482 GHz). The channel select unit 630 may be a switch or multiplexer or other device capable of selecting one strip over another.

In an alternate embodiment, the off-chip amplifier 615a may be removed from the GPS strip. This approach may be more suitable for low cost/low performance markets that emphasize circuit integration rather than GPS tracking precision. In another alternate embodiment that may be used to serve even lower cost/lower performance markets, a single strip solution may be employed that eliminates the need for two antennas as well as the need for channel selection unit 630 and the BT/GPS input 606.

FIG. 7 shows a IF module 712 that may be used within the integrated BLUETOOTH/GPS receiver of FIG. 5a. Similar to the IF module 312 discussed with respect to FIG. 3a, the IF module 712 of FIG. 7 passes the content of a desired signal from the lower frequency portion 351 (referring briefly back to FIG. 3) and presents approximately equal signal power to the digitizing module.

As discussed above with respect to IF filters 317a, 317b of FIG. 3a, the GPS channel bandwidth is approximately 2.25 MHz and a BLUETOOTH channel bandwidth is approximately 1.25 MHz. In one embodiment, the passband of each IF filter 617a, 617b of FIG. 6 is fixed at approximately 1.25 MHz regardless if the signal being received corresponds to a BLIJETOOTH or GPS signal. The use of a 1.25 MHz bandwidth for GPS signals reduces the higher frequency content of the GPS signal(s) which, in turn, reduces location accuracy.

In another embodiment, the IF filters 617a, 617b are configured to change their passband in response to the state of the BT/GPS input 606. For example, if the GPS state is selected the IF filters 617a, 617b are configured to have an approximately 2 MHz bandwidth; and, if the BLUETOOTH state is selected the IF filters 617a, 617b are configured to have an approximately 1.25 Mhz bandwidth. As such, the GPS signal processing path may be said to have a 2 MHz bandwidth while the BLUETOOTH signal processing path may be said to have a 1.25 MHz bandwidth.

The bandwidth of a filter is typically changed by altering the value of one or more capacitors within the filter. Capacitance may be changed through use of a varacter (i.e., a voltage controlled capacitance); by switching (i.e., with a switch) the coupling of more/less capacitance into/from the filter; or by altering the bias current of a “gmC” filter. The bandwidth of the filters 717a, 717b may change between values other than those described just above. The arrows through the filters 717a, 717b seen in FIG. 7 are meant to indicate that different bandwidths may be employed depending on which state (BLUETOOTH or GPS) the receiver is in.

Recalling the discussion of the ALC and limiting IF module approaches (provided above with respect to the IF module 312 of FIG. 3a), note that the ALC approach has noticeable benefits for GPS signals. In the case of GPS, the finite amplitude resolution of the analog to digital conversion (that is performed by the digitizing module after the IF module) corresponds to weakening the GPS signal. As such, the receiver suffers some degree of sensitivity degradation.

Use of a limiter in the IF module for GPS signals can effectively worsen this affect (because a limiter corresponds to a single bit of amplitude resolution). The receiver can suffer a sensitivity loss of approximately 3 dB as a result. That is, the strength of the minimum detectable signal rises by 3 dB as compared to the strength of the minimum detectable signal that could be received if limiting is not employed. An ALC approach, however, preserves the analog nature of the received waveform and therefore substantially reduces the 3 dB sensitivity loss.

Thus, in the embodiment of FIG. 7, an ALC approach is employed for GPS signals and a limiting approach is employed for BLUETOOTH signals. That is, in response to the BT/GPS control input 706, amplifiers 718a, 718b correspond to a pair of: 1) limiting amplifiers if the BLUETOOTH state is selected; or 2) VGA amplifiers (with feedback to provide automatic level control) if the GPS state is selected. Thus the GPS signal processing path may be said to have an ALC approach while the BLUETOOTH signal processing path may be said to have a limiting approach. In an embodiment, a VGA amplifier is converted into a limiting amplifier by applying a large enough voltage to a “gain control” input (that controls the VGA gain) such that a gain sufficient to cause clipping is created. In another embodiment, the BT/GPS control input is coupled to a channel select unit (not shown) that forces the signal through a limiting amplifier (if BLUETOOTH mode is selected) or a VGA amplifier (if GPS mode is selected). The use of arrows through the amplifiers 718a, 718b seen in FIG. 7 is meant to indicate that different amplification techniques (e.g., limiting or ALC) may be employed depending on the state (e.g., BLUETOOTH or GPS) of the receiver.

In an alternate embodiment (e.g., that is directed to higher performance and higher allowable cost), amplifiers 718a, 718b correspond to VGA amplifiers in an ALC approach for both the GPS and BLUETOOTH modes. As such, the BT/GPS control input 706 is not utilized. In another embodiment (e.g., that is directed to lower performance but lower allowable cost) amplifiers 718a, 718b correspond to limiters. As such, again, the BT/GPS control input 706 is not utilized.

FIG. 8a shows a first exemplary digitizing module 813a that may be employed by the integrated BLUETOOTH/GPS receiver of FIG. 5a. The digitizing module 813a of FIG. 8a corresponds to a combination of the digitizing modules 313b and 313c shown in FIGS. 3b and 3c, respectively. Effectively, according to the operation of the digitizing module 813a of FIG. 8a, channel select unit 823 enables a digitizing strip that corresponds to the digitizing module 313b of FIG. 3b if the BT/GPS input 806a is positioned in the GPS state. Channel select unit 823 also enables a digitizing strip that corresponds to the digitizing module 313c of FIG. 3c if the BT/GPS control input 806a is positioned in the BLUETOOTH state.

Note that in the embodiment of FIG. 8a, a common A/D converter 820a is used for both strips. As such, a common resolution and sampling rate may be applied to either type of signal (GPS or BLUETOOTH). In an embodiment, the A/D converter 820a provides 2⁶ resolution levels for both signals types and, as such, provides for less sensitivity loss than the A/D converters typically used for GPS signals (which typically have less than 2² resolution levels).

FIG. 8b shows another embodiment of a digitizing module 813b. When the BT/GPS control input 806b reflects the GPS state, channel “B” of both channel select units 824a, 824b is selected. As such, the IF module output signals are presented to IQ combiner 819b. When the BT/GPS control input 806b reflects the BLUETOOTH state, channel “A” of both channel select units 824a, 824b is selected. As such, the IF module output signals are each respectively routed through FSK demodulation strips 860a and 860b prior to being combined by the IQ combiner 819b. After the IQ combiner 819b, the signals are converted from the analog domain to the digital domain by the A/D converter 819b.

Note that the techniques described above can be used to design an integrated “frequency hopping/GPS” receiver where frequency hopping corresponds to frequency hopping networks that include BLUETOOTH as well as non BLUETOOTH networks (e.g., HomeRF and/or IEEE 802.11).

b. Integrated BLUETOOTH/GPS Frequency Synthesizer

Recall from the discussion of FIG. 5b that the local frequency fs created by the frequency synthesizer 500 of FIG. 5a is adjusted during transitory times Ts1, Ts2, Ts3, and Ts4. More specifically, during transitory periods Ts1 and Ts3, the local frequency fs is adjusted from a frequency (e.g., between 2.400 GHz and 2.480 GHz) used to receive a BLUETOOTH channel to a frequency (e.g., 1.575 GHz) used to receive a GPS signal.

Furthermore, during transitory periods Ts2 and Ts4, the local frequency fs is adjusted from a frequency (e.g., 1.574 GHz) used to receive a GPS signal to a frequency (e.g., between 2.400 GHz and 2.480 GHz) used to received a BLUETOOTH channel. Note that as the time needed by the frequency synthesizer 500 to make these reference adjustments decreases (i.e., as the width of transitory periods Ts1, Ts2, Ts3, Ts4 decrease), the time devoted to receiving GPS information between BLUETOOTH packets increases.

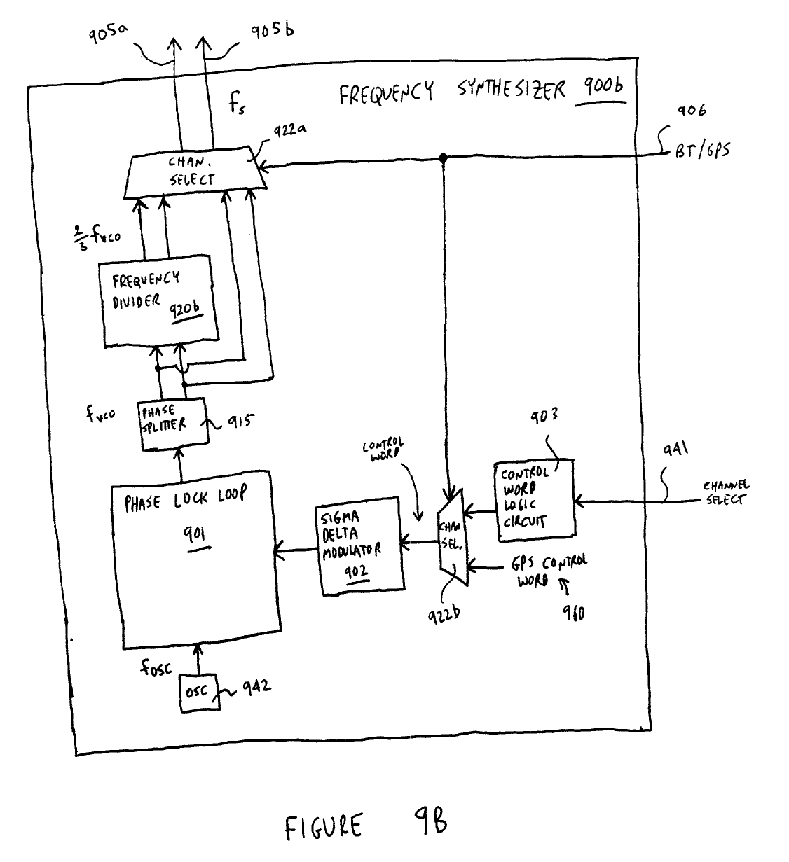

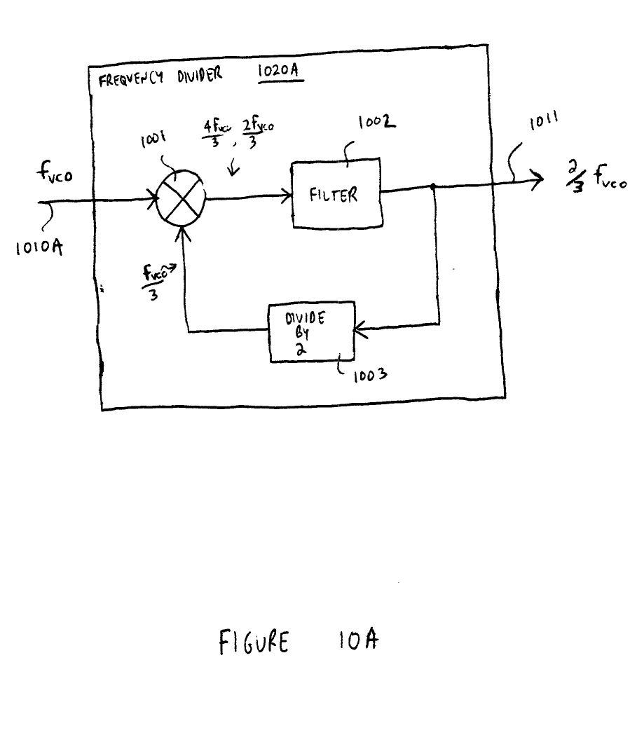

Thus, as described with respect to the discussion of FIG. 5b, in one embodiment the transitory periods Ts1, Ts2, Ts3, Ts4 are designed to be as low as 10 us (which enables as much as 200 us of GPS signal reception between BLUETOOTH packets). FIG. 9a shows a frequency synthesizer embodiment 900a that may be used for the frequency synthesizer 500 described with respect to FIGS. 5a and 5b and, as such, can rapidly adjust between GPS and BLUETOOTH frequencies.

Note that the frequency synthesizer of FIG. 9a includes a fractional N frequency synthesizer (such as the Fractional N synthesizer discussed with respect to FIG. 4) which is embodied by a phase lock loop circuit 901 and sigma delta modulator 902. The transitory periods Ts1, Ts2, Ts3 and Ts4 described with respect to FIG. 5b correspond to time periods allotted for the phase lock loop to re-acquire phase lock in light of a change in feedback division information provided by the sigma delta modulator 902. Fractional N synthesizers, because of the operation of the sigma delta modulator, are capable of rapidly acquiring phase lock while providing adequately low jitter (i.e., a stable local frequency fs) after phase lock has been obtained.

As a result, before phase lock occurs, the loop bandwidth is high enough to allow for rapid changes in the loop filter output voltage (which corresponds to a rapid change in local frequency and low phase lock acquisition time). Jitter is reduced as well because the feedback division information is translated to sufficiently higher frequencies (with respect to the loop filter bandwidth) by the sigma delta modulator which results in a stable loop filter voltage (i.e., reduced jitter) once phase lock occurs.

Jitter characterizes the temporal stability of the local frequency (fs). That is, the local frequency may “jitter about” (rather than remain fixed for all times at) the correct local frequency fs. The frequency domain equivalent of jitter is referred to as “phase noise”. Low phase noise is beneficial, with respect to the reception of a BLUETOOTH signal, because it keeps reception limited to the desired channel and prevents the reception of neighboring channels (referred to in the art as “reciprocal mixing”). Low phase noise is also beneficial with respect to the reception of GPS signals because the more accurately the phase of a GPS signal can be determined, the more accurately the location of the wireless device can be determined.

Recalling that higher loop bandwidths allow the phase lock loop to change frequency faster, note that (for a given loop bandwidth) the greater the magnitude of the frequency change needed to acquire phase lock, the longer it takes for phase lock to be obtained. Fractional N synthesizers easily change frequency from one BLUETOOTH channel to another BLUETOOTH channel because the frequency change is limited to approximately 80 MHz or less (e.g., there is an 80 MHz difference between 2.400 GHz and 2.480 GHz). For a worst case frequency change of approximately 80 MHz, a fractional N synthesizer may be readily designed that can acquire phase lock within a narrow transitory period.

However, note that the frequency changes associated with transitory periods Ts1, Ts2, Ts3, and Ts4 involve a frequency change from/to a BLUETOOTH carrier frequency to/from a GPS carrier frequency. As GPS signals are carried at 1.574 GHz (for the L1 band), the magnitude of the frequency change is on the order of 800 to 900 MHz. From a loop bandwidth perspective, it is very difficult to design a phase lock loop that can quickly reacquire phase lock over such a large frequency change and still provide a local frequency fs with tolerable phase noise.

As such, as seen in the frequency synthesizer embodiment 900a of FIG. 9a, a frequency divider 920a may be used to assist the frequency synthesizer in achieving a large frequency change over a small transitory amount of time. According to the synthesizer embodiment 900a of FIG. 9a, when the BT/GPS control input 906 is positioned to the BLUETOOTH state, the phase lock loop output 930 is selected by the first channel selection unit 921a.

Furthermore, a second channel select unit 921b selects the output of the control word logic circuit 903. As such, in the BLUETOOTH state, the channel select input 941 affects the control word value that is presented to the sigma delta modulator 902 (which correspondingly controls the phase lock loop output signal frequency f_{vco}). In the BLUETOOTH state, the phase lock loop output signal frequency f_{vco} can range over the 2.400 GHz to 2.480 GHz ISM band. The output of the first channel select unit 921 correspondingly provides a local frequency fs sufficient for receiving the channel indicated by the channel select unit 941.

When the BT/GPS control input 906 is positioned to the GPS state, the channel select unit 921a selects the output of a frequency divider 920a that receives, as an input, the phase lock loop output 930. In an embodiment, the frequency divider 920a divides the frequency of the phase lock loop output signal f_{vco} by ⅔. In this embodiment, the second channel select unit 921b provides the sigma delta modulator 902 with a GPS control word 960 that corresponds to a phase lock loop output signal frequency f_{vco} of 2.361 GHz.

As such, a 1.574 GHz local frequency is provided at the output of the frequency divider 920a (i.e., (⅔)×2.361 GHz=1.574 GHz). The first channel select unit 921a selects the frequency divider 920a output which provides a local frequency fs sufficient for receiving a GPS signal. Note that the GPS state phase lock loop frequency of 2.361 GHz is close to the 2.400 GHz to 2.480 GHz ISM band used for BLUETOOTH. As such, during the transitory periods Ts1, Ts2, Ts3, Ts4 discussed above, the magnitude of the worst case (i.e., largest) frequency change asked of the phase lock loop is approximately a 119 MHz (2.480 GHz 2.361 GHz=119 MHz).

A phase lock loop having rapid phase lock times and adequate phase noise may therefore be readily designed. That is, because the operative frequency range of the phase lock loop for both states (GPS and BLUETOOTH) has been configured to be significantly less than a range that spans from a GPS carrier frequency to the ISM band, a phase lock loop 901 having low phase lock acquisition times and low phase noise is achievable. A phase lock loop's operative frequency range corresponds to the frequency range used for the particular function the phase lock loop is designed to support (e.g., BLUETOOTH signal reception and GPS signal reception).

Alternate embodiments may choose to use a division factor other than ⅔. In a further alternate embodiment, a frequency multiplier may be placed at the output leg of the phase lock loop circuit that is used for the BLUETOOTH state. In this alternate embodiment, the frequency divider may not be necessary. Generally, various combinations of multiplication and/or division may be applied at either or both legs (i.e., the GPS leg and the BLUETOOTH leg) between the first channel selection unit 921a and the phase lock loop 901, so that the operative frequency range of the phase lock loop 901 is less than the difference between the GPS carrier frequency and any of the frequencies within the ISM band.

Note that because the particular embodiments discussed above are directed to BLUETOOTH, the applicable frequency hopping network band corresponds to the ISM band (since that is the band employed by BLUETOOTH). Other frequency hopping networks (e.g., other than BLUETOOTH such as HomeRF or 802.11) may take advantage of the approach discussed herein by designing the operative frequency range of a phase lock loop to be less than the difference between the GPS carrier frequency and any of the frequencies used by the frequency hopping network. The range of airborne frequencies used by a frequency hopping network may be referred to as a frequency hoping network band.

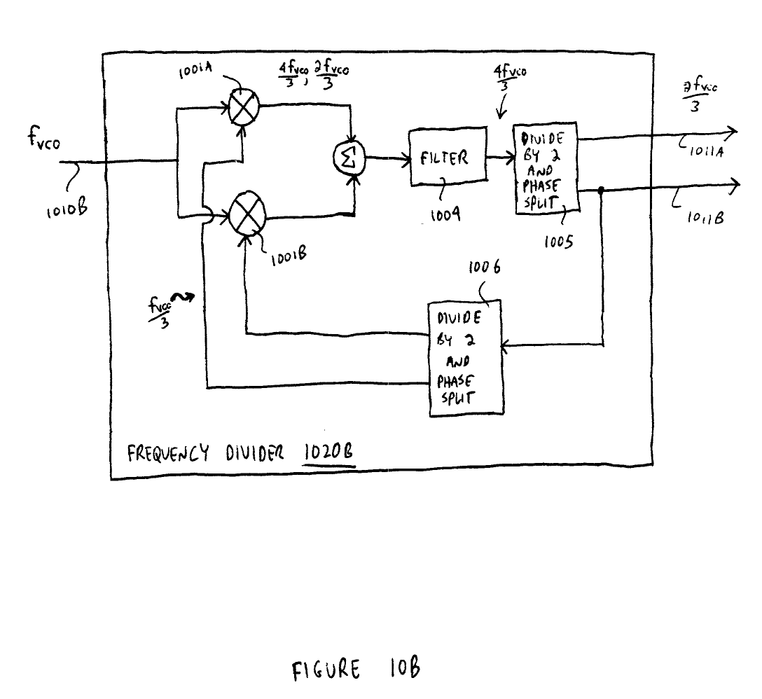

FIG. 10a shows a frequency divider embodiment 1020a that may be used for the frequency divider 920a of FIG. 9a. The frequency division approach of FIG. 9a may be referred to as regenerative division. In regenerative division, an input frequency f_{vco} is mixed with a signal having a frequency at a fraction of the input frequency (e.g., ⅓ f_{vco} as seen in FIG. 10A). Consistent, with mixing principles, the signal at the mixer output has terms: an additive term (e.g., f_{vco}+(⅓)f_{vco}=(4/3)f_{vco}); and a subtractive term (e.g., f_{vco}−(⅓)f_{vco}=(⅔)f_{vco}). The subtractive term is then passed by a filter 1002. The filter output corresponds to the divider output 1011 which is also feedback to the mixer 1001 to provide the signal having a fraction of the input frequency.

FIG. 9b shows a more sophisticated frequency synthesizer embodiment 900b. The frequency synthesizer embodiment 900b of FIG. 9b generates quadrature arms between the phase lock loop 901 and first channel select unit 922a (rather than after the first channel select unit 921a as seen in FIG. 9a). As a result, the first channel select unit 922a of FIG. 9b is a quadrature channel select unit (as opposed to the single ended channel select unit 921a of FIG. 9a). Other than the frequency divider 920b, the components of the frequency synthesizer 900b of FIG. 9b operate as described with respect to FIG. 9a.

FIG. 10b shows a more sophisticated regenerative divider 1020b that may be employed by the frequency synthesizer of FIG. 9b. In the regenerative division approach of FIG. 10b, quadrature arms are provided as an input to the divider 1020b because the phase splitter 915 feeds the divider 1020b input.

As described in more detail below, the output of the feedback divider and phase split 1006 produces a frequency of (⅓)f_{vco}. Therefore mixers 1001A, 1001B each generate an additive term of (4/3)f_{vco} and a subtractive term of (⅓)f_{vco}. Due to the nature of quadrature signalling, the addition of the mixer output signals by combiner 1019 cancels the subtractive (⅓)f_{vco} term. As such, the additive term (4/3)f_{vco} is presented to the filter 1004 input.

Filter 1004 passes the additive (4/3)f_{vco} term. Filter 1004 allows the regenerative divider 1020b to migrate toward the proper frequency during power up and, as such, does not need to be a high precision filter. Furthermore, because the filter 1004 passes the additive term it has a higher center frequency than the filter 1002 of FIG. 10a. These factors allow filter 1004 of FIG. 10b to be a small filter which results in efficient surface area consumption.

The first divide by two and phase split unit 1005 provides quadrature arms at the divider output 1011A, 1011B having the proper frequency (⅔)f_{vco} (i.e., “divide by 2” refers to a frequency division by 2). The feedback divide by two and phase split unit 1006 converts a divider 1011B output into a quadrature (⅓)f_{vco} signal.

Thus an integrated frequency hopping/GPS receiver and corresponding frequency synthesizer have been described.

Note that embodiments of the present description may be implemented not only within a semiconductor chip but also within machine readable media. For example, the designs discussed above may be stored upon and/or embedded within machine readable media associated with a design tool used for designing semiconductor devices. Examples include a netlist formatted in the VHSIC Hardware Description Language (VHDL) language, Verilog language or SPICE language. Some netlist examples include: a behaviorial level netlist, a register transfer level (RTL) netlist, a gate level netlist and a transistor level netlist. Machine readable media also include media having layout information such as a GDS-II file. Furthermore, netlist files or other machine readable media for semiconductor chip design may be used in a simulation environment to perform the methods of the teachings described above.

Thus, it is also to be understood that embodiments of this invention may be used as or to support a software program executed upon some form of processing core (such as the CPU of a computer) or otherwise implemented or realized upon or within a machine readable medium. A machine readable medium includes any mechanism for storing or transmitting information in a form readable by a machine (e.g., a computer). For example, a machine readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. An apparatus, comprising:
an integrated frequency hopping/GPS receiver that receives a downconversion signal from a frequency synthesizer, said frequency synthesizer having a phase lock loop with an operative frequency range that is less than the difference between an ISM band frequency and a GSM carrier frequency.

2. The apparatus of claim 1 wherein said wireless receiver further comprises an RF module having an off chip amplifier and an on chip amplifier for GPS signal processing path, said RF module having an on chip amplifier for said frequency hopping signal processing path.

3. The apparatus of claim 1 wherein said wireless receiver further comprises an IF module having an IF filter, said IF filter having a first bandwidth for said GPS signal processing path and a second bandwidth for said frequency hopping signal path.

4. The apparatus of claim 1 wherein said wireless receiver further comprises a digitizing module having an IQ combiner for said GPS signal processing path and an FSK demodulator for said frequency hopping signal path.

5. An apparatus, comprising:
an RF module within a wireless receiver, said RF module having an off chip amplifier and an on chip amplifier for a GPS signal processing path, said RF module having an on chip amplifier for a frequency hopping signal processing path.

6. An apparatus, comprising:
an IF module within a wireless receiver, said IF module having an IF filter, said IF filter having a first bandwidth for a GPS signal processing path and a second bandwidth for a frequency hopping signal path.

7. An apparatus, comprising:
a digitizing module within a wireless receiver, said digitizing module having an IQ combiner for a GPS signal processing path and an FSK demodulator for a frequency hopping signal path.

8. An apparatus, comprising:
a frequency synthesizer having a phase lock loop with an operative frequency range that is less than the difference between an ISM band frequency and a GSM carrier frequency, said phase lock having a feedback coupled to a sigma delta modulator, said sigma delta modulator configured to receive a control word for receiving a frequency hopping channel or a control word for receiving a GPS signal.

9. An apparatus, comprising:
a wireless receiver having a GPS signal processing path and a frequency hopping signal path, said wireless receiver having a control input that enables said GPS signal processing path or said frequency hopping signal processing path.
